(19) United States
(12) Patent Application Publication
(10) Pub. No.: US 2025/0334826 A1
(43) Pub. Date: Oct. 30, 2025

(54) FIBER-INTEGRATED BI-DIRECTIONAL MICROWAVE-OPTICAL TRANSDUCER BASED ON RARE-EARTH-ION DOPED THIN FILMS

(71) Applicant: THE UNIVERSITY OF CHICAGO, Chicago, IL (US)

(72) Inventor: Tian Zhong, Chicago, IL (US)

(21) Appl. No.: 18/869,887

(22) PCT Filed: May 31, 2023
(86) PCT No.: PCT/US2023/023926

§ 371 Date: Nov. 27, 2024

Related U.S. Application Data
(60) Provisional application No. 63/347,640, filed on Jun. 1, 2022.

(51) Int. Cl. G02F 1/00; H01P 7/06; H01P 7/10

(52) U.S. Cl. CPC G02F 1/0036; H01P 7/065; H01P 7/10; G02F 2203/15

(57) ABSTRACT

A microwave-optical transducer device, comprising: an optical cavity formed by a first dielectric substrate having a first optical reflector disposed thereon and a second dielectric substrate having a second optical reflector disposed thereon; a spin ensemble material disposed in the optical cavity, the spin ensemble material disposed on the second dielectric substrate; a planar microwave resonator disposed proximal to the spin ensemble material and inductively coupled thereto; and wherein: the optical cavity is configured to expose the spin ensemble material to an optical-range electromagnetic field; the microwave resonator is configured to expose the spin ensemble material to a micro wave-range electromagnetic field; the spin ensemble material, when exposed to a magnetic field and to an optical pump field having a driving frequency Ωp, to emit the optical-range electromagnetic field upon exposure to the microwave electromagnetic field, and to emit the microwave electromagnetic field upon exposure to the optical-range electromagnetic field.

### RELATED APPLICATIONS

This application claims the benefit of U.S. Provisional Application No. 63/347,640, filed on Jun. 1, 2022. The entire teachings of the above application(s) are incorporated herein by reference.

### BACKGROUND OF THE INVENTION

The ability to transfer quantum states encoded in microwave frequency excitations to light, and vice versa, would greatly enrich superconducting qubits as a platform for quantum information processing. Superconducting qubits operate in the microwave frequency regime and can interact strongly with microwave photons.

Thermal noise at room temperature and the relatively high loss of room temperature microwave transmission lines means that microwave photons are inefficient for long distance quantum communication. Quantum memory devices

Optical photons are ideal carriers of quantum information for long-distance transmission with minimal loss in fibers and no interference with the environment. Therefore a quantum device allowing coherent conversion of microwave photons to optical photons are highly desired, which will enable long-distance interconnection between remote quantum computers.

### SUMMARY OF THE INVENTION

In an example embodiment, the present invention is a microwave-optical transducer device, comprising: an optical cavity formed by a first dielectric substrate having a first optical reflector disposed thereon and a second dielectric substrate having a second optical reflector disposed thereon; a spin ensemble material disposed in the optical cavity, the spin ensemble material disposed on the second dielectric substrate; a planar microwave resonator disposed proximal to the spin ensemble material and inductively coupled thereto; and wherein: the optical cavity is configured to expose the spin ensemble material to an optical-range electromagnetic field; the microwave resonator is configured to expose the spin ensemble material to a microwave-range electromagnetic field; the spin ensemble material, when exposed to a magnetic field and to an optical pump field having a driving frequency Ωp, to emit the optical-range electromagnetic field upon exposure to the microwave electromagnetic field, and to emit the microwave electromagnetic field upon exposure to the optical-range electromagnetic field.

In another example embodiment, the present invention is a method of transducing a first range of electromagnetic field into a second range of electromagnetic field, the method comprising: providing a device of any of the embodiments described herein; applying a magnetic field in the spin ensemble material; exposing the spin ensemble material to an optical pump field having a driving frequency Ωₚ; and exposing the spin ensemble material to electromagnetic field of a first range, thereby causing the spin ensemble material to emit electromagnetic field of a second range, and thereby transducing the electromagnetic field of the first range into the electromagnetic field of the second range, wherein either the first range is optical and the second range is microwave or the first range is microwave and the second range is optical.

Devices and methods disclosed herein provide for efficient bi-directional conversion between microwave and optical electromagnetic radiation down to the quantum level. It enables quantum transduction which allows conversion of quantum information between microwave and optical domains for interconnecting remote quantum computers over an optical network. The devices and methods disclosed herein also improves the transduction (conversion) efficiency by orders of magnitude.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic diagram showing Er energy levels and splitting of the excited state at different frequency scales. The overall spin Hamiltonian and the respective interaction terms responsible for different hybrid couplings are shown at the top.

FIG. 2 is a schematic diagram showing a heterogeneous material architecture of an exemplary rare-earth quantum transducer described herein.

FIG. 3A is a schematic diagram of one embodiment of a rare-earth magneto-optic transducer described herein. The size of the spin ensemble material matches the mode of a vertical fiber cavity. FIG. 3B depicts the energy levels for excited-state Raman Heterodyne. FIG. 3C is a schematic diagram of an example embodiment of a transducer described herein.

FIG. 4A through FIG. 4F show a fiber-integrated magneto-optic transducer according to an example embodiment of the present invention and illustrate its properties. FIG. 4A is a schematic diagram of an example embodiment of a transducer described herein. FIGS. 4B and 4C, are SEM images of the transducer device shown in FIG. 4A, which comprises a low-Z superconducting microwave resonator inductively coupled to an Er:Y₂O₃ spin ensemble material. A fiber microcavity is vertically integrated by focusing on the Y₂O₃ disk. FIG. 4E, top and bottom panels, show the measurement results of optical and microwave resonances in the transducer, showing Qₒ=2.8×10⁵ and Q_{MW}=1.2×10⁴. FIG. 4E is a plot showing expected magneto-optic transduction efficiency n in the embodiment of the transducer shown in FIG. 4A.

### DETAILED DESCRIPTION OF THE INVENTION

A description of example embodiments of the invention follows.

In various embodiments, the present invention provides devices and methods that effect microwave-optical quantum transductions through magneto-optic coupling. As used herein, the phrase “atomic transduction” refers to the processes that involve internal degrees of freedom of atoms. In various embodiments, atoms can be rare-earth atoms (doping atoms or atoms of a stoichiometric rare-earth material). Alternatively, atoms can be those of a ferromagnetic material. Advantageously, the disclosed devices and methods do not require addressing of individual atoms in the host and can be implemented by collective coupling to large ensembles of atoms for enhanced efficiency and fidelity.

The field of quantum information science is rapidly advancing beyond singular physics (e.g., superconducting circuits, phonons, spins, atoms, ions, photons) towards a hybrid system architecture in which disparate degrees of freedom co-exist and coherently couple to each other. Such couplings underpin quantum transduction, in which a quantum state encoded in one domain is reversibly converted into another, ideally with a unit fidelity despite the presence of noise and dissipation. Quantum transduction between microwave and optical photons is an essential technology that would enable interconnections of distant superconducting or ion-based quantum processors through low-loss optical channels for realizing distributed quantum computation, long-range quantum communication and sensing networks.

Ideal unitary (i.e. lossless) quantum transduction is achieved when the coupling strength dominates over any decoherence rate in each interacting degree of freedom. One key challenge is to retain the strong interaction between a system and an external drive while protecting it from decoherence by the environment.

In an example embodiment, the devices and methods disclosed herein employ ground-state and excited-state quantum transduction pathways between spins, photons, microwaves and acoustic phonons in a unified material platform based on rare-earth-doped crystals. At cryogenic temperatures, the 4f intra-shell transitions of rare-earth dopants in solids, shielded by the 5s, 5p outer shells, can exhibit extremely sharp optical emission (half-width in a kHz range) and ultra-long spin coherence times ranging from seconds up to hours. The combination of strong magnetism (i.e., large gyromagnetic ratio (or g-factor, g, having a value of approximately 15) and long optical/spin coherence lends itself to a robust magneto-optic coupling. Without being bound by any particular theory, it is believed that new rare-earth electro-optic and acousto-optic transduction mechanisms contribute to the observed conversion effects: the former originates in the optical Stark effect, and the latter is a result of the strong spin-orbit and crystal field interactions in this dopant material.

Example embodiments of devices and methods disclosed herein employ the hybrid coupling of ground states and optically excited states of rare-earth dopants to magnetic, electric, and acoustic fields. Using excited-state spins are advantageous in certain circumstances. For example, the excited states possess similar or better spin coherence properties than ground states, but they are effectively decoupled from a large number of unexcited spectator spins. As used herein, the term “spectator atoms” refer to atoms of the spin ensemble material that are capable, when exposed to a magnetic field and to an optical pump field having a driving frequency Ωₚ, to emit the optical-range electromagnetic field upon exposure to the microwave electromagnetic field, and to emit the microwave electromagnetic field upon exposure to the optical-range electromagnetic field, however are not involved in the conversion process. Those spectator spins do not participate in the transduction process, but they would incur loss and induce decoherence. Furthermore, modulation of excited levels directly translates into frequency or phase shifts in optical fields, bridging microwave and the optical domains and enabling microwave-optical transductions.

### Rare-Earth Quantum Materials

Rare-earth elements are exemplified by lanthanides, scandium, and yttrium. They are common dopants in oxide host crystals, such as yttrium aluminum garnet, Y₂SiO₅ (YSO), Y₂O₃, replacing Y as substitutional impurities. The 4f shell of rare-earth dopants is shielded from the environment by the 5s and 5p outer shells. The 4f-4f intra-shell transitions are weakly allowed in the presence of a crystal field, which results in sharp optical emission with high quantum efficiency. Sharp optical transitions (equivalent quality factor over 1011) at cryogenic temperatures are correlated with long optical lifetimes (up to milliseconds) but weak oscillator strengths. Electronic Zeeman and hyperfine transitions in radio frequencies are abundant in 4f shells. When doped into hosts with small nuclear magnetic moments such as YSO or Y₂O₃, record long spin coherence times—6 hours in Eu:YSO and 1.3 seconds in Er:YSO—have been achieved. Furthermore, both optical and spin transitions exhibit inhomogeneous broadenings that are typically 10⁵-10⁶ times the homogeneous linewidths, suitable for multiplexing and high bandwidth operations. Rare-earth material can also be applied to optical quantum memories.

### Rare-Earth Transduction Physics

Rare-earth ions, especially erbium (Er), have a very long optical excited-state lifetime (approximately 10 milliseconds) that is suitable for performing quantum transduction protocols. It has now been discovered that excited-state spin coherence can be significantly enhanced from the ground state due to suppressed interactions with spectator spins and reduced coupling to noise. The Er optical homogeneous linewidth is as narrow as approximately 100 Hz at cryogenic temperatures, offering a high-resolution probe for interactions with other physical degrees of freedom in the material.

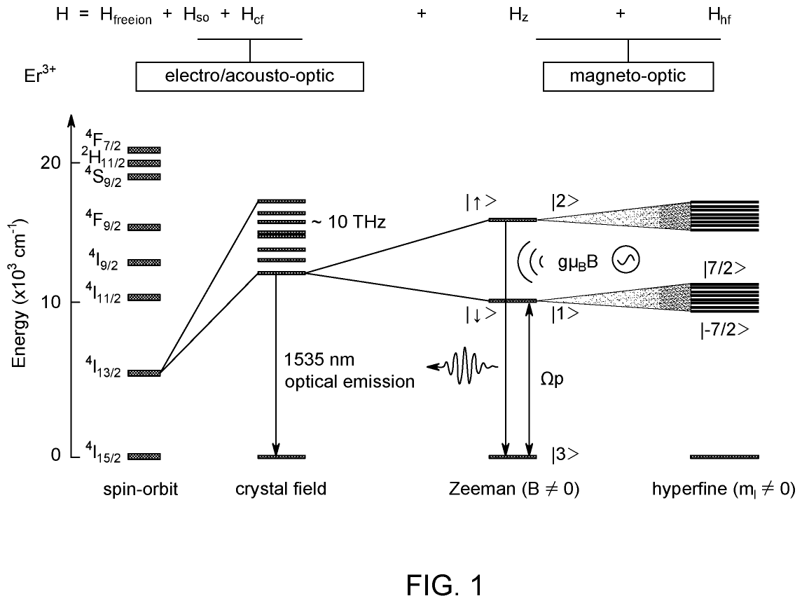

A typical energy level diagram of Er is shown in FIG. 1. FIG. 1 shows Er energy levels and splitting of the excited state at different frequency scales. The overall spin Hamiltonian and the respective interaction terms responsible for different hybrid couplings are shown at the top. The last two terms, Zeeman and hyperfine splittings are the underlying interactions responsible for magneto-optic transduction. Taking Zeeman levels |1-3> as an example, when the transition |1>-|3> are pumped with an optical field with Rabi frequency (pump strength) ΩP, transduction between a microwave field resonant with |1>-|2> transition and an optical field between |2>-|3> takes place.

The crystal field splitting of each spin-orbit level is large, in the range of 1-10 THz, which suggests a large permanent dipole that can be modulated using electric fields. Furthermore, the spin-orbit plus crystal field interactions lead to a coupling mechanism between spins and phonons through perturbed wavefunctions in a vibrating lattice. In addition, each crystal field level is a Kramer doublet whose degeneracy can be lifted by an external magnetic field. The resulting Zeeman spin transitions have large magnetic moments (g-factor of about 15 in Er), giving rise to strong coupling to magnetic fields. For rare-earth isotopes with nuclear spins, hyperfine interactions also couple nuclear spins to optical transitions.

### Magneto-Optic Coupling

Consider a collection of three-level rare-earth ions with energy levels shown in FIG. 1 (under Zeeman term). As shown in FIG. 1, the magnetic field of an input microwave photon of frequency ω_{MW} is coupled to the spin transition between |1 [symbol] and |2 [symbol] . An optical driving field, with frequency ωₚ is coupled to the transition |1 [symbol] -|3 [symbol] . Here, the spin |1 [symbol] -|2 [symbol] can be electronic or hyperfine transitions in either ground or excited state of the ion. The driving field ωₚ upconverts the input to an optical photon at frequency ωₒ, as the dipole transition between |3 [symbol] and |2 [symbol] is excited. Energy conservation demands a three-photon resonance condition ωₒ=ω_{mw}+ωₚ. The Hamiltonian is given by

$${H}_{MO} / ℏ = {\sum }_{k}^{N} ( {Ω}_{P} {σ}_{32 , k} + {g}_{s , k} {σ}_{21 , k} b + {g}_{o , k} {σ}_{31 , k} a ) + H . c .$$

where Ω_{P} is the Rabi frequency of the coherent drive, a and b are annihilation operators for the microwave and optical modes, respectively. g_{s,k} and g_{o,k} are coupling strengths for the k^{th} atom to the microwave and optical fields. The summation is over N atoms interacting with all three fields. Working in a detuned regime where atoms' internal dynamics are adiabatically eliminated, the effective Hamiltonian takes the form: Ω_{P}gₛg₀*a^{†}b+H.c.[20], which is identical to the parametric beam-splitter Hamiltonian in nonlinear optics, optomechanics, or coupled cavities sharing a partially transmissive mirror. By coupling the rare-earth ensembles to both optical and microwave cavities, a unit quantum conversion efficiency can be achieved if the impedance matching condition is met: \sqrt{Ngₒ²/κₐγo}·\sqrt{Ngₛ²/κ_{b}γₛ}≥1 where γ_{o,s} is the inhomogeneous linewidth of the ensemble and κ_{a,b} is the cavity decay rate for the microwave or optical cavities. This impedance matching thus amounts to unit collective coupling cooperativities of both optical and microwaves photons.

### Heterogeneous Material Architecture

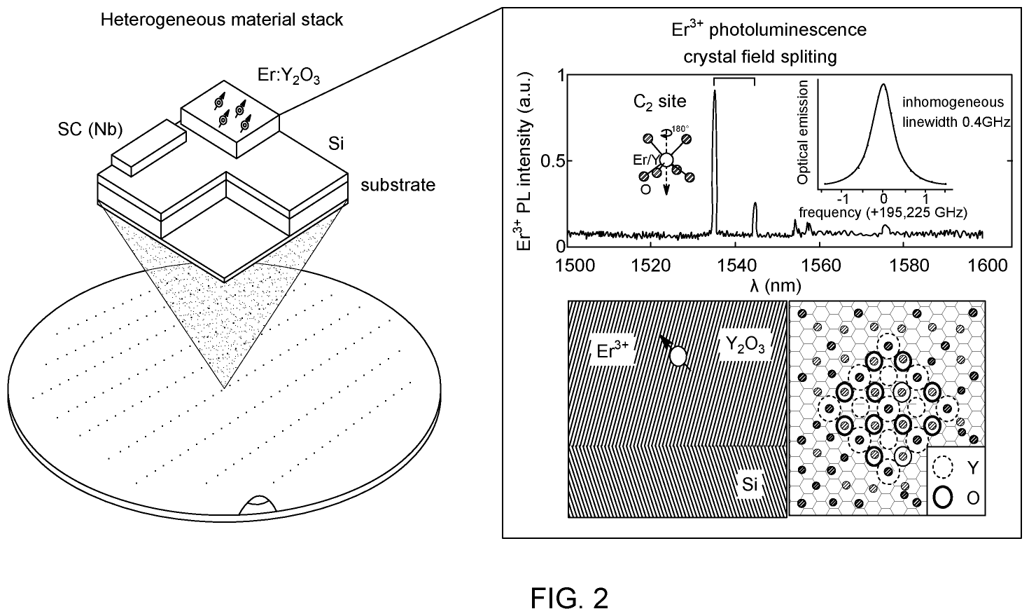

The realization of a hybrid quantum transduction system relies on a versatile material architecture that allows the stacking of multi-functional subsystems (photonics, spins, superconducting circuits) while preserving their couplings and quantum coherence characteristics. A unified material architecture that enables all transduction modalities is shown in FIG. 2. FIG. 2, left panel, shows an epitaxial Er:Y₂O₃ on Si wafer and schematics of material stacking. FIG. 2, right panel, shows optical spectroscopy of epitaxial Er:Y₂O₃. Top right: Er photoluminescence showing crystal field levels in two symmetry (C₂ and C₃ᵢ) sites. The narrowest optical inhomogeneous linewidth was measured to be 400 MHz. Bottom right: TEM image of the Y₂O₃ crystal lattice and the Y₂O₃—Si interface.

Wafer-scale, single crystal, epitaxial films of rare-earth-doped yttrium oxide (Y₂O₃) was grown using molecular beam epitaxy (MBE) on silicon. Y₂O₃ possesses a cubic bixbyite crystal structure with a lattice constant twice that of silicon that can be taken advantage of to grow epitaxial Y₂O₃ single-crystal films. The growth of 5-1000 nm thick Y₂O₃ on silicon occurs via a two-dimensional layer-by-layer growth mode, resulting in smooth, uniform films. This bottom-up assembly enables scalable integration of several critical quantum transduction subsystems:

Photonic subsystem: The single crystal Y₂O₃ film measures a refractive index of 1.89 and low optical absorption of α=0.02 dB/cm at telecom band from ellipsometry measurement. The film on Si (111) could be grown on insulator (SOI) wafers to enable the fabrication of high-quality Si nanophotonic waveguide and resonators using mature lithography and etching techniques.

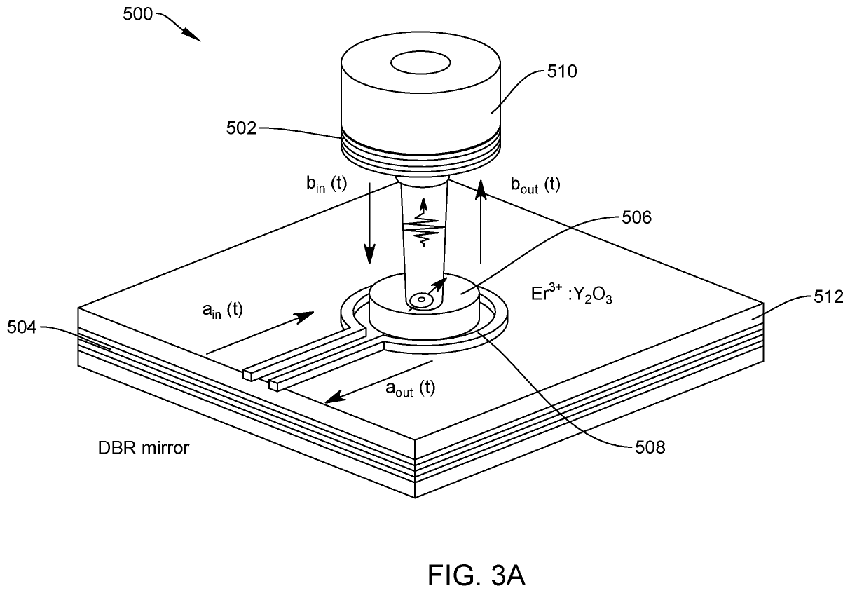

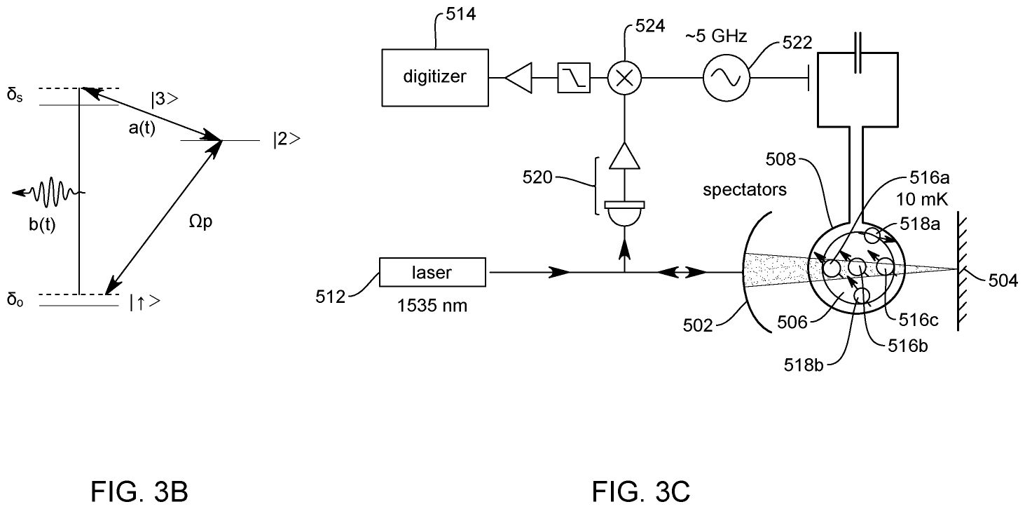

Superconducting microwave subsystem: Superconducting (SC) material Nb on silicon is deposited to create microwave resonators at ˜5 GHz, which has measured Q exceeding 500,000. Microwaves are coupled inductively to Er spins in Y₂O₃ via a co-planar architecture as illustrated in FIG. 3A.

Spin subsystem: Dopant atomic density ranging from 10 parts per billion (ppb) to stoichiometric composition (i.e., Er₂O₃) can be precisely controlled during the growth. This control allows tuning the atomic ensemble density on demand for various transduction modalities. Furthermore, the Y₂O₃ films are etched using a custom-developed dry etch recipe to form spatial patterns required by each modality. Lastly, dopants' proximity to interfaces is controlled via delta-doping to mitigate decoherence due to interfacial defects.

### Optical Excited-State Spectroscopy of Er Dopants in Y₂O₃

Rare-earth dopants can occupy two inequivalent sites in Y₂O₃, with C₃ᵢ and C₂ point group symmetries, respectively. In example embodiments, Erbium (Er) was selected as the dopant of interest because Er has convenient telecom emission at 1.5 μm wavelength, for which silicon is transparent and is most technologically relevant for fiber-based optical quantum networks. Optical and spin spectroscopic measurements were conducted on the epitaxial Er:Y₂O₃ material. A typical photoluminescent excitation (PLE) spectrum is shown in FIG. 2, top right panel. Multiple lines corresponding to two symmetry sites and several crystal field split levels are revealed in the 1530-1580 nm range. The highest peak at 1535.6 nm is the Y₁-Z₁ transition in the C₂ site. The inset shows the optical inhomogeneous linewidth of that transition, which is 6 GHz in the as-grown films but drastically improves to only 0.4 GHz (for 20 ppm doping) after aggressive annealing. An extremely narrow homogeneous linewidth of 580 Hz was also measured at a temperature of approximately 100 mK dilution temperatures. A long Er optical-excited state lifetime of 8.5 ms was measured for the C₂ site, consistent with bulk Er:Y₂O₃ measurement. The optical dipole oscillator strength is higher for the C₂ site, making it a preferred site for optical driving, though C₃ᵢ sites possess intriguing symmetry that could be exploited for spin-phonon couplings. The ground and excited state electron paramagnetic resonances of Er:Y₂O₃ were characterized using X-band EPR at 4K temperature. The anisotropic g-tensors were measured to be in excellent agreement with that in bulk Y₂O₃ crystals. The average spin inhomogeneous linewidth is approximately 20 MHz. The optimal microwave driving configuration is a DC B field along Y₂O₃ crystallographic axis, such that the transverse g-factor reaches a maximum of g_{ac}=7.4. All of the above spectroscopic parameters for transduction are summarized in Table 1.

TABLE 1
Transduction relevant spectroscopy of epitaxial Er:Y₂O₃ at millikelvin temperatures

| | | optical | optical inhom. | optical | spin inhom. | excited-state | excited-state |
|---|---|---|---|---|---|---|---|
| | λ | T₁ | linewidth Γᵢₙₕ^{o} | T₂ | Linewidth Γᵢₙₕ^{s} | spin T₂ | g_{ac} |
| Epitaxial | 1535 nm | 8.5 ms | 0.4 GHz | 0.55 ms | 17.9 MHz | 7.1 ms | 7.4 |
| Er:Y₂O₃ | | | (20 ppm) | | | | |

### Strong Enhancement of Excited-State Spin Coherence

Without being bound by any particular theory, it is believed that this enhancement comes from the strongly suppressed magnetic dipolar interactions with unexcited (spectator) spins, and from weaker coupling to the fluctuating magnetic noise in the host. This result confirms our central thesis for exploiting long-lived excited-state rare-earth dopants for high-fidelity quantum transductions.

### Magneto-Optic Transduction

An efficient magneto-optic coupling in rare-earth-doped materials was realized by selectively coupling microwaves to the optically excited dopants, suppressing the number of spectator spins plaguing the transduction process (inducing loss, adding noise, and decoherence), resulting in high-fidelity microwave-optical quantum conversion.

The underlying physics for magneto-optic transduction is the coherent Raman heterodyne scattering process in a three-level scheme shown in FIG. 3B.

In the embodiment shown in FIG. 3A, the device 500 comprises: an optical cavity formed by a first dielectric substrate 510 having a first optical reflector 502 disposed thereon and a second dielectric substrate 512 having a second optical reflector 504 disposed thereon; a spin ensemble material 506 disposed in the optical cavity, the spin ensemble material disposed on the second dielectric substrate 512; a microwave resonator 508 disposed proximal to the spin ensemble material 506 and inductively coupled thereto. In the example embodiment shown in FIG. 3A the optical cavity is configured to expose the spin ensemble material 506 to an optical-range electromagnetic field (bᵢₙ(t)), the microwave resonator 508 is configured to expose the spin ensemble material 506 to a microwave-range electromagnetic field (aᵢₙ(t)). In this example embodiment, the spin ensemble material 506, when exposed to a magnetic field and to an optical pump field having a driving frequency Ωₚ, to emit the optical-range electromagnetic field (bₒᵤₜ(t)) upon exposure to the microwave electromagnetic field (aᵢₙ(t)), and to emit the microwave electromagnetic field (aₒᵤₜ(t)) upon exposure to the optical-range electromagnetic field (bᵢₙ(t)).

In one aspect, the embodiment shown in FIG. 3A each of the first and second optical reflector 502 and 504 can be a distributed Bragg reflector.

In another aspect, the example embodiment shown FIG. 3A, the spin ensemble material 506 comprises a rare-earth-doped crystal.

In a further aspect, an example embodiment shown in FIG. 3A, the first dielectric substrate 510 can comprise an optical fiber tip configured to direct the optical-range electromagnetic field into the optical cavity.

A schematic diagram of the device shown in FIG. 3A is shown in FIG. 3C. FIG. 3C also depicts the optical pump 512 having a driving frequency Ωₚ, and a digitizer 514. The device depicted in FIG. 3C comprises the following elements: 512: telecom pump laser; 502: a high reflectivity mirror at front; 504: a high reflectivity mirror at back; 506: materials containing spin ensembles; 518_{a-b}: spectator spins (atoms that are not participating in the transduction process); 516_{a-c}: spins of the atoms that do participate in the transduction process; 508: superconducting microwave circuit; 522: microwave source to drive the superconducting circuit; 524: microwave mixer that mixes signals from input and output paths; 514: digitizer, a device that records the extracted signal of the transduced optical signal from the device.

The advantages of the device shown in FIG. 3A (implementing the 3-level quantum system shown in FIG. 3B) are that excited ions have spin transitions detuned from ground state spectator spins, leading to significantly longer spin coherence.

Furthermore, microwaves only resonantly couple to the excited state ions (516ₐ-516_{c} in FIG. 3C) that participate in the transduction process. Spectator spins (518ₐ-519_{b} in FIG. 3C) in the ground state are not coupled, so the microwave loss and spontaneous emission due to spectator spins is minimized.

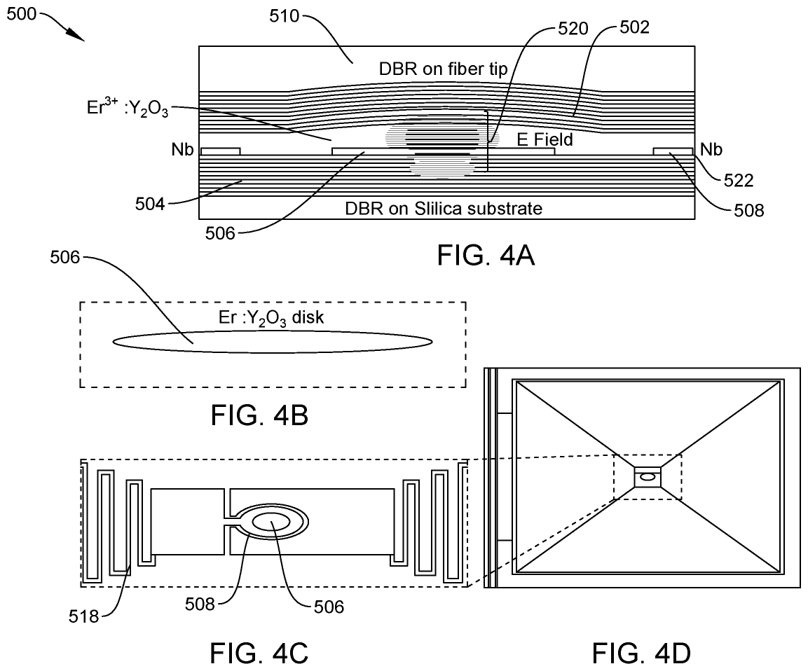

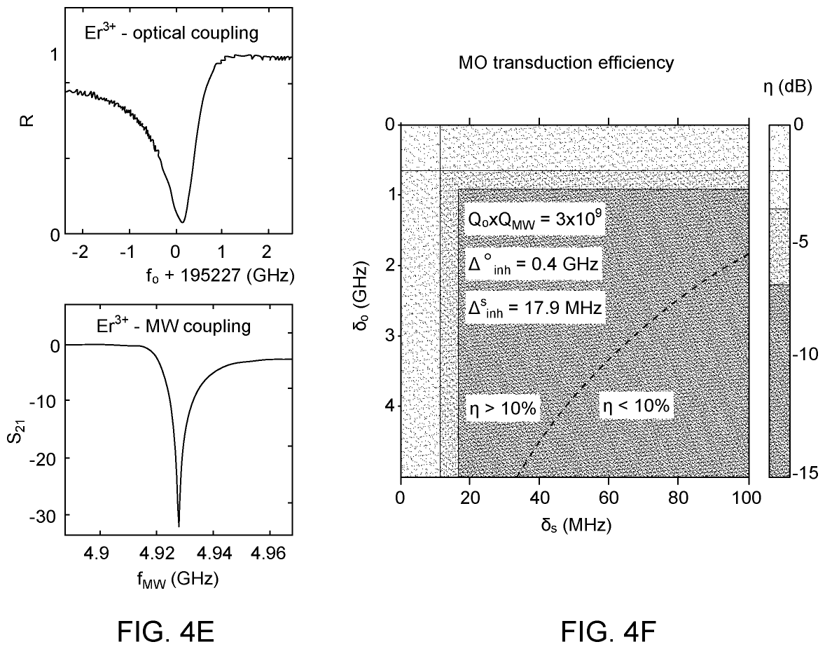

An example embodiment of the device 500 is also shown in FIGS. 4A-4D. The embodiment of the spin ensemble material 506 shown in FIGS. 4A-4D comprises a lithographically patterned, 500 nm-thick Er:Y₂O₃ disk coupled to a microwave resonator 508. In the embodiment, the MW resonator 508 comprises concentric Nb superconducting loop-gap resonator. The co-planar Nb resonator is fabricated directly on the same silicon substrate as Y₂O₃. Optically, the circular Y₂O₃ disk spatially overlaps with a fiber Fabry Perot cavity mode 520 formed between a high-reflection coated fiber facet (e.g. fiber tip 510 with reflector 502) and a distributed Bragg reflector 504 stack on the backside of the silicon substrate 522 (i.e. between the optical reflectors 502 and 504). The fiber facet 510 is ablated using a CO₂ laser to create a concave mirror, forming a hemispherical confocal cavity normal to the device plane. This coupling scheme maximizes the mode overlap of the Er spin ensembles material 506 with the microwave and optical modes, which is a key factor for impedance matching, as discussed next. Furthermore, the orthogonal arrangement of optical and microwave components minimizes adverse crosstalk such as scattering of laser onto the superconducting circuits.

In an example embodiment, the device depicted in FIGS. 4A through 4C comprises the following elements: 502: top distributed Bragg reflector (DBR) mirror on the fiber tip; 504: bottom DBR mirror; 506: spin ensemble material; 508: superconducting microwave circuit (inductor part); 510: optical fiber; 518: superconducting microwave circuit (capacitor part); 520: confined optical field between the mirrors; 522: a spacer layer (e.g. Si) between the DBR mirror and the spin ensemble materials (e.g. Y₂O₃).

### Optical-microwave impedance matching

As a long-standing challenge to optical-microwave transduction, phase matching needs to be fulfilled between the optical and microwave fields whose wavevectors differ by approximately 5 orders of magnitude.

In some embodiments, the optical cavity formed by the two reflectors and the microwave resonator “cavity” (collectively, “cavities”) can be used to facilitate phase matching. When cavities are used, the requirement of a high mode overlap or a filling factor between three interacting fields must be satisfied:

$${\int }_{{V}_{C}} χ ( r ) ϕ ( r ) ϕ ( r ) {dr}^{3}$$

where V_{c} is the crystal volume. (The microwave and optical mode volumes are denoted by V_{μ} and Vₒ, respectively.) The x(r), ϕ(r), φ(r) are the mode functions for the microwave and two optical modes (one of which is the optical pump filed). In the embodiment shown in FIGS. 4A-4D, the finite spatial extent of the Er ensemble material 506 within the disk self-aligns it to both cavities, increasing this filling factor to F=0.05.

FIG. 4E (top and bottom panels) shows the spectra of both cavities. The fiber optical cavity measures a Qₒ=2.8×10⁵ and a finesse of 4×10⁴ when detuned from the Er transition, and is highly mechanically stable in the dilution fridge. The high finesse also verifies a low, undetectable optical absorption in the Y₂O₃ film. The superconducting microwave resonator measures a Q_{MW}=1.2×10⁴. Other experimental parameters include Er optical inhomogeneous linewidth in Y₂O₃=400 MHz, spin inhomogeneous linewidth 17.9 MHz, Er optical dipole moment 2.5×10⁻³² C m, and Er excited state transverse magnetic moment g_{ac}=7.4 μB (μB is Bohr magneton) and a pump Rabi frequency ˜1 MHz (with a few nW pump power into the fiber cavity).

Based on the above parameters, the magneto-optic photon number conversion efficiency η of the current device is calculated as a function of optical and spin detuning. The results are shown in FIG. 4F. The detuning 80 and Os are the same as those shown in FIG. 3B. It can be seen that unit transduction efficiency is achievable when driving both transitions near resonance, but at the expense of reduced bandwidth and higher spontaneous noise. When working in the detuned regime, a large parameter space can still be accessed in which the efficiency remains above 10% (FIG. 4F). In the detuned case, the transduction bandwidth is given by the geometric mean of the two cavity linewidths, which in the device shown in FIGS. 4A-4F is approximately 20 MHz.

While coupling of Er spins to superconducting resonators has been shown before with a typical single spin coupling (g_{μ}) of approximately 1 Hz, the devices and methods disclosed herein benefit from a low-impedance superconducting resonator (Z=10 ohm) which enhances the collective coupling strength to approximately 10 MHz for 106 spins. The high Q resonance in current devices has also shown resilience to a high DC magnetic field up to 1T, provided that the DC field is carefully trimmed to be perpendicular to the field generated by the superconducting circuit. In the experiments described herein a 6-1-1 T 3D vector magnet was used to achieve this precise field alignment.

### Coherent Bi-Directional Conversion

A Raman Heterodyne measurement setup shown in FIG. 3C can be used to verify the coherent magneto-optic conversion process. An optical pump field generated by the pump 512, detuned from the fiber cavity (formed by reflectors 502 and 504), is sent to the fiber cavity. A fast photodiode 520 detects the reflected signal from the cavity, and the output is mixed with a microwave source 522 that is also resonantly driving the superconducting resonator 508. The mixer quadrature 524 outputs are amplified and averaged using a digitizer 514 for measuring both the absorptive and dispersive signals. The bi-directional photon number conversion efficiency is measured using this heterodyne detection, both with a classical microwave/optical input (i.e., high mean photon number in the input mode), and to characterize added noise and fidelity of the transduction process, as discussed next.

### Noise and Fidelity Characterization

The expectedly efficient magneto-optic conversion offers a powerful tool to investigate various noise and decoherence processes that may degrade the transduction fidelity. It is possible to characterize the added noise using attenuated coherent state microwave photons as input (aᵢₙ). A decoy-state strategy can be employed similar to that for characterizing quantum memories, in which weak coherent states with different mean photon numbers αᵢₙ are injected. At least 3 input states with αᵢₙ=0 (vacuum), ˜0.01, and ˜1 can be used. The vacuum state will inform any noise source independent of the input, such as scattered pump light, thermal noise, or detector dark noise. Whereas the non-vacuum coherent-state input allows us to bound the noise component that correlates with the input state, including spontaneous emission from spectator spins.

The qubit transduction fidelity can also be characterized using a set of coherent-state inputs with discrete-variable encoding. Input photons can be encoded into a time-bin qubit state with early and late time modes. After filtering the optical pump and isolating the converted output, the transduction process fidelity can be measured from the overlap of input-output time-bin states following the standard tomography technique. Repeating this step for different input mean photon numbers will lead to a lower bound for the quantum transduction fidelity if a qubit input were used. As a standard benchmark, a true quantum transduction process can be detected by crossing a classical fidelity threshold of ⅔.

### Materials Loss at MW Frequencies

The optical loss of Y₂O₃ is measured to be sufficiently low (α=0.02 dB/cm) for high-Q optical resonators. In various embodiments, the dielectric loss at the microwave regime can be remediated. The Nb on as-grown Y₂O₃ superconducting microwave resonators showed an intrinsic quality factor of ˜10,000. Further loss reduction can be achieved, in one embodiment, by annealing the as-grown Y₂O₃ films in foaming or oxygen gas as oxygen vacancies are known defects elevating the dielectric absorption in this material. In another embodiment, the use an alternative thin-film material by top-down thinning of a bulk Y₂O₃ crystal can be employed. In one embodiment, Y₂O₃ membranes can be reduced down to submicron thickness using the chemical mechanical polishing (CMP) technique. The initial results showed a 500 nm thick Y₂O₃ membrane with a surface roughness of 0.3 nm rms. Co-planar microwave resonators with Q exceeding 106 have been routinely demonstrated with similar bulk oxide materials (e.g., YSO).

### Optical Heating and Induced Noise

The optical pump in all transduction modalities may cause heating and elevated temperatures of the device, increasing thermal noise for the microwave fields and the spins. In various embodiments, heating effects can be mitigated by using pulsed optical excitations with low duty cycles. Meanwhile, substrate material with high thermal conductivity can be used (e.g., a sapphire wafer).

### Optical-SC isolation

Illumination of the superconducting circuit by stray light causes degraded quality factor or even breaking of superconductivity. In various embodiments, this effect can be mitigated with optimized inductor loop size with respect to the fiber mode. In further example embodiments, the stray light can be reduced by placing the input taper waveguide at an orthogonal orientation and far away from the circuit.

### Optical Pump Filtering

In various embodiments, an optical pump that is a few GHz detuned from the transduced optical signal can be used. In some aspects, it may be desirable to filter the optical field produced by such a pump in order to demonstrate the quantum-level operation. In example embodiments, this filtering can have 120-150 dB extinction. The following strategies can be employed to fulfill this task:

(1) Cascaded high-finesse stable optical cavities. In certain embodiments, a low-cost fiber-pigtailed stable confocal cavity can be deployed, having a typical optical linewidth of less than 5 MHz with a long-term drift of less than 100 kHz/hr. At 5 GHz microwave frequency, each such cavity provides greater than 50 dB extinction of the pump light, and three cavities fiber-connected in series can achieve the desired pump filtering.

(2) Optically thick Er:Y₂O₃ ceramics as narrowband spectral filtering. In certain embodiments, long Er:Y₂O₃ polycrystalline ceramics can be deployed, which has a peak absorption of 3.6 OD/cm and a linewidth of 0.4 GHz at cryogenic temperatures. In certain aspects, a metal coat can be deposited at the end facets of this ceramic and multi-optical passes through the bulk can be affected (meaning optical signals can go back and forth between coated surfaces multiple times such that it gets attenuated completely). Four passes of a 2-cm bulk would yield approximately 130 dB pump extinction.

### Additional Embodiments

In various example embodiments, in any of the transducer devices described hereinabove, the spin ensemble material can comprise a ferromagnetic material.

In further example embodiments, in any of the transducer devices described hereinabove, the spin ensemble material can comprise a stoichiometric rare-earth material.

In view of the foregoing, in a first example embodiment, the present invention is a microwave-optical transducer device. In a first aspect, the device comprises an optical cavity formed by a first dielectric substrate having a first optical reflector disposed thereon and a second dielectric substrate having a second optical reflector disposed thereon; a spin ensemble material disposed in the optical cavity, the spin ensemble material disposed on the second dielectric substrate; a planar microwave resonator disposed proximal to the spin ensemble material and inductively coupled thereto; and wherein: the optical cavity is configured to expose the spin ensemble material to an optical-range electromagnetic field; the microwave resonator is configured to expose the spin ensemble material to a microwave-range electromagnetic field; the spin ensemble material, when exposed to a magnetic field and to an optical pump field having a driving frequency Ωp, to emit the optical-range electromagnetic field upon exposure to the microwave electromagnetic field, and to emit the microwave electromagnetic field upon exposure to the optical-range electromagnetic field.

As used herein, “inductively coupled” means that the spin ensemble material is exposed to magnetic field of the MW.

In a 2^{nd} aspect, the device further comprises a permanent magnet configured to apply the magnetic field to the spin ensemble material. The remainder of features and elements of the second aspect are as described above with respect to the 1^{st} aspect.

In a 3^{rd} aspect, the first optical reflector is configured to focus the optical-range electromagnetic field on the spin ensemble material. The remainder of features and elements of the 3^{rd} aspect are as described above with respect to the 1^{st} and 2^{nd} aspects.

In a 4^{th} aspect, the microwave resonator is a superconducting microwave resonator. The remainder of features and elements of the 4^{th} aspect are as described above with respect to the 1^{st} through 3^{rd} aspects.

In a 5^{th} aspect, the device comprises a superconducting microwave resonator, wherein the superconducting microwave resonator comprises a material selected from the group consisting of Nb, NbN, and NbTiN. The remainder of features and elements of the 5^{th} aspect are as described above with respect to the 1^{st} through 4^{th} aspects.

In a 6^{th} aspect, the microwave resonator is planar and is disposed in a first plane; the spin ensemble material is planar, and is disposed in the first plane; and the optical cavity has an optical axis that is non-coplanar with the first plane. For example, the first plane is substantially perpendicular to the optical axis of the optical cavity. The remainder of features and elements of the 6^{th} aspect are as described above with respect to the 1^{st} through 5^{th} aspects.

In a 7^{th} aspect, each of the first and second optical reflector is a distributed Bragg reflector. The remainder of features and elements of the 7^{th} aspect are as described above with respect to the 1^{st} through 6^{th} aspects.

In an 8^{th} aspect, each of the first and second substrate comprises silica. The remainder of features and elements of the 8th aspect are as described above with respect to the 1st through 7th aspects.

In a 9^{th} aspect, the spin ensemble material comprises a rare-earth-doped crystal. Examples of the rare-earth dopant include from Ce, Nd, Sm, Gd, Dy, Tm, Er, or Yb. In an example embodiment, the rare-earth dopant is Er. In example embodiments, the crystal is selected from yttrium aluminum garnet, Y₂SiO₅, or Y₂O₃, LiYF₄, CaF₂, TiO₂, SrTiO₂, or YVO₄. In an example embodiment, the crystal is selected from yttrium aluminum garnet, Y₂SiO₅, or Y₂O₃. In another example embodiment, the crystal is YVO₄. The remainder of features and elements of the 9^{th} aspect are as described above with respect to the 1^{st} through 8^{th} aspects.

In a 10^{th} aspect, the spin ensemble material comprises a ferromagnetic material. In example embodiments, the ferromagnetic material is selected from Yttrium Iron Garnet (YIG), Er₂O₃, and ErFeO₃. The remainder of features and elements of the 10^{th} aspect are as described above with respect to the 1^{st} through 9^{th} aspects.

In an 11^{th} embodiment, the spin ensemble material comprises a stoichiometric rare-earth material. In example embodiments, the stoichiometric rare-earth material is selected from Er₂O₃, ErLiF₄, and ErVO₄. For example, the stoichiometric rare-earth material is Er₂O₃. The remainder of features and elements of the 11th aspect are as described above with respect to the 1^{st} through 10^{th} aspects.

In a 12^{th} aspect, the first dielectric substrate comprises an optical fiber tip configured to direct the optical-range electromagnetic field into the optical cavity. The remainder of features and elements of the 12^{th} aspect are as described above with respect to the 1^{st} through 11^{th} aspects.

In a 13^{th} aspect, the second dielectric substrate is substantially planar and the first dielectric substrate is domed. The remainder of features and elements of the 13^{th} aspect are as described above with respect to the 1^{st} through 12^{th} aspects.

In a 14^{th} aspect, the device further comprises a laser configured to emit the optical pump field. The remainder of features and elements of the 14^{th} aspect are as described above with respect to the 1^{st} through 13^{th} aspects.

In a second example embodiment, the present invention is a method of transducing a first range of electromagnetic field into a second range of electromagnetic field. In a 1^{st} aspect, the method comprising providing a device according to any aspect of the first example embodiments described hereinabove; applying a magnetic field in the spin ensemble material; exposing the spin ensemble material to an optical pump field having a driving frequency Ωp; and exposing the spin ensemble material to electromagnetic field of a first range, thereby causing the spin ensemble material to emit electromagnetic field of a second range, and thereby transducing the electromagnetic field of the first range into the electromagnetic field of the second range, wherein either the first range is optical and the second range is microwave or the first range is microwave and the second range is optical.

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

What is claimed is:

1. A device, comprising:
an optical cavity formed by a first dielectric substrate having a first optical reflector disposed thereon and a second dielectric substrate having a second optical reflector disposed thereon;
a spin ensemble material disposed in the optical cavity, the spin ensemble material disposed on the second dielectric substrate;
a planar microwave resonator disposed proximal to the spin ensemble material and inductively coupled thereto; and
wherein:
the optical cavity is configured to expose the spin ensemble material to an optical-range electromagnetic field;
the microwave resonator is configured to expose the spin ensemble material to a microwave-range electromagnetic field;
the spin ensemble material, when exposed to a magnetic field and to an optical pump field having a driving frequency Ωₚ, to emit the optical-range electromagnetic field upon exposure to the microwave electromagnetic field, and to emit the microwave electromagnetic field upon exposure to the optical-range electromagnetic field.

2. The device of claim 1, further comprising a permanent magnet configured to apply the magnetic field to the spin ensemble material.

3. The device of claim 1 or 2, wherein the first optical reflector is configured to focus the optical-range electromagnetic field on the spin ensemble material.

4. The device of any one of claims 1-3, wherein the microwave resonator is a superconducting microwave resonator.

5. The device of claim 4, wherein the superconducting microwave resonator comprises a material selected from the group consisting of Nb, NbN, and NbTiN.

6. The device of any one of claims 1-5, wherein:
the microwave resonator is disposed in a first plane;
the spin ensemble material is planar, and is disposed in the first plane; and
the optical cavity has an optical axis that is non-coplanar with the first plane.

7. The device of any one of claim 6, wherein the first plane is substantially perpendicular to the optical axis of the optical cavity.

8. The device of any one of claims 1-7, wherein each of the first and second optical reflector is a distributed Bragg reflector.

9. The device of any one of claims 1-8, wherein each of the first and second substrate comprises silica.

10. The device of any one of claims 1-9, wherein the spin ensemble material comprises a rare-earth-doped crystal.

11. The device of claim 10, wherein the rare-earth dopant is selected from Ce, Nd, Sm, Gd, Dy, Tm, Er, or Yb.

12. The device of claim 11, wherein the rare-earth dopant is Er.

13. The device of any one of claims 10-12, wherein the crystal is selected from yttrium aluminum garnet, Y₂SiO₅, or Y₂O₃, LiYF₄, CaF₂, TiO₂, SrTiO₂, or YVO₄.

14. The device of any one of claims 10-13, wherein the crystal is selected from yttrium aluminum garnet, Y₂SiO₅, or Y₂O₃, LiYF₄, CaF₂, TiO₂, or SrTiO₂.

15. The device of claim 14, wherein the crystal is selected from yttrium aluminum garnet, Y₂SiO₅, or Y₂O₃.

16. The device of any one of claim 1 or 3-9, wherein the spin ensemble material comprises a ferromagnetic material.

17. The device of claim 16, wherein the ferromagnetic material is selected from Yttrium Iron Garnet (YIG), Er₂O₃, and ErFeO₃.

18. The device of any one of claims 1-9, wherein the spin ensemble material comprises a stoichiometric rare-earth material.

19. The device of claim 18, wherein the stoichiometric rare-earth material is selected from Er₂O₃, ErLiF₄, and ErVO₄.

20. The device of claim 18, wherein the stoichiometric rare-earth material is Er₂O₃.

21. The device of any one of claims 1-20, wherein the first dielectric substrate comprises an optical fiber tip and configured to direct the optical-range electromagnetic field into the optical cavity.

22. The device of any one of claims 1-20, wherein the second dielectric substrate is substantially planar and the first dielectric substrate is domed.

23. The device of any one of claims 1-20, further comprising a laser configured to emit the optical pump field.

24. A method of transducing a first range of electromagnetic field into a second range of electromagnetic field, the method comprising:
providing a device of any one of claims 1-23;
applying a magnetic field in the spin ensemble material;
exposing the spin ensemble material to an optical pump field having a driving frequency Ωₚ; and
exposing the spin ensemble material to electromagnetic field of a first range, thereby causing the spin ensemble material to emit electromagnetic field of a second range, and thereby transducing the electromagnetic field of the first range into the electromagnetic field of the second range,
wherein either the first range is optical and the second range is microwave or the first range is microwave and the second range is optical.
